(19) United States
(12) Patent Application Publication
(10) Pub. No.: US 2019/0306562 A1
(43) Pub. Date: Oct. 3, 2019

(54) VESSEL FOR TRANSPORTING CONTENT AND PLAYBACK POSITION INFORMATION

(71) Applicant: ARRIS Enterprises LLC, Suwanee, GA (US)

(72) Inventor: Jing-Yuan Zhang, Shanghai (CN)

(21) Appl. No.: 15/552,082

(22) PCT Filed: Dec. 19, 2016
(86) PCT No.: PCT/CN2016/110836

§ 371 Date: Aug. 18, 2017

(51) Int. Cl. H04N 21/433; H04N 21/422; H04N 21/4363

(52) U.S. Cl. CPC H04N 21/4333; H04N 21/43637; H04N 21/42207

(57) ABSTRACT

Methods, systems, and computer readable media may facilitate the transport of content and playback position information from one media device to another. In embodiments, a wireless device such as a bi-directional remote control unit (e.g., Bluetooth, or RF4CE (radio frequency for consumer electronics)) or other device configured to receive and transmit wireless communications may be used to download, from a media device, and temporarily store information associated with content being output by the media device, wherein the information includes an identification of the content being output and an identification of a current playback or resume point within the piece of content. The wireless device may transmit the information associated with the content to a second media device, and the second media device may use the information to retrieve the piece of content identified by the information and to initiate playback of the content from the position identified by the information.

### TECHNICAL FIELD

This disclosure relates to the transport of content and playback position information from one media device to another.

### BACKGROUND

It is common for a viewer of a piece of content being output to a display from a first media device to pause playback of the content at the first media device and to resume playback of the content at a second media device. For example, a viewer that is watching a piece of content (e.g., live/linear television content, VoD (video-on-demand) content, OTT (over-the-top) content, DVR (digital video recorder) content, etc.) in one room through a first media device may want to resume watching the piece of content in a different room through a different media device. However, in order to resume playback of the content, a viewer is typically forced to pause the content at the first media device, find the piece of content at the second media device (e.g., through a guide or recording list user interface), initiate playback of the content at the second media device, and utilize one or more trickplay functions to locate a desired resume point within the piece of content. This process is time-consuming and may cause a viewer to miss a portion of the content being viewed. Therefore, it is desirable to improve upon methods and systems for resuming playback of content at a different media device.

### BRIEF DESCRIPTION OF THE DRAWINGS

FIG. 1 is a block diagram illustrating an example network environment operable to facilitate the transport of content and playback position information from one media device to another.

FIG. 2 is a block diagram illustrating an example system operable to facilitate the transport of content and playback position information from one device to another device.

FIG. 3 is a flowchart illustrating an example process operable to facilitate the transport of content and playback position information from one media device to another.

FIG. 4 is a block diagram of a hardware configuration operable to facilitate the transport of content and playback position information from one media device to another.

Like reference numbers and designations in the various drawings indicate like elements.

### DETAILED DESCRIPTION

It is desirable to improve upon methods and systems for resuming playback of content at a different media device. Methods, systems, and computer readable media may facilitate the transport of content and playback position information from one media device to another. In embodiments, a wireless device such as a bi-directional remote control unit (e.g., Bluetooth, or RF4CE (radio frequency for consumer electronics)) or other device configured to receive and transmit wireless communications may be used to download, from a media device, and temporarily store information associated with content being output by the media device, wherein the information includes an identification of the content being output and an identification of a current playback or resume point within the piece of content. The wireless device may transmit the information associated with the content to a second media device, and the second media device may use the information to retrieve the piece of content identified by the information and to initiate playback of the content from the position identified by the information.

An embodiment of the invention described herein may include a method comprising: (a) receiving, at a wireless device, information identifying a piece of content that is being output from a first media device and information identifying a current playback position of the output of the piece of content from the first media device, wherein the information identifying the piece of content and the information identifying the current playback position are received from the first media device within one or more wireless transmissions; (b) storing the information identifying the piece of content and the information identifying the current playback position at the wireless device; (c) identifying a second media device; and (d) outputting the information identifying the piece of content and the information identifying the current playback position from the wireless device to the second media device, wherein the information identifying the piece of content and the information identifying the current playback position are output within one or more wireless transmissions, and wherein the information identifying the piece of content and the information identifying the current playback position facilitate a retrieval of the piece of content and an initiation of playback of the piece of content from the current playback position at the second media device.

According to an embodiment of the invention, the wireless device comprises a bi-directional remote control unit.

According to an embodiment of the invention, the information identifying the piece of content and the information identifying the current playback position are received at the wireless device in response to a designated user input being received at the wireless device.

According to an embodiment of the invention, the second media device is identified and the information identifying the piece of content and the information identifying the current playback position are output to the second media device in response to a designated user input being received at the wireless device.

According to an embodiment of the invention, identifying the second media device comprises, determining that the wireless device is paired with the second media device.

According to an embodiment of the invention, identifying the second media device comprises, determining that the wireless device is within a predetermined range of the second media device.

According to an embodiment of the invention, the one or more wireless transmissions carrying the information identifying the piece of content and the information identifying the current playback position from the first media device to the wireless device comprise one or more Bluetooth or Radio Frequency for Consumer Electronics transmissions.

An embodiment of the invention described herein may include a wireless device comprising: (a) an interface configured to be used to receive information identifying a piece of content that is being output from a first media device and information identifying a current playback position of the output of the piece of content from the first media device, wherein the information identifying the piece of content and the information identifying the current playback position are received from the first media device within one or more wireless transmissions; (b) storage configured to store the information identifying the piece of content and the information identifying the current playback position at the wireless device; (c) one or more modules configured to identify a second media device; and (d) wherein the interface is further configured to be used to output the information identifying the piece of content and the information identifying the current playback position from the wireless device to the second media device, wherein the information identifying the piece of content and the information identifying the current playback position are output within one or more wireless transmissions, and wherein the information identifying the piece of content and the information identifying the current playback position facilitate a retrieval of the piece of content and an initiation of playback of the piece of content from the current playback position at the second media device.

An embodiment of the invention described herein may include one or more non-transitory computer readable media having instructions operable to cause one or more processors to perform the operations comprising: (a) receiving, at a wireless device, information identifying a piece of content that is being output from a first media device and information identifying a current playback position of the output of the piece of content from the first media device, wherein the information identifying the piece of content and the information identifying the current playback position are received from the first media device within one or more wireless transmissions; (b) storing the information identifying the piece of content and the information identifying the current playback position at the wireless device; (c) identifying a second media device; and (d) outputting the information identifying the piece of content and the information identifying the current playback position from the wireless device to the second media device, wherein the information identifying the piece of content and the information identifying the current playback position are output within one or more wireless transmissions, and wherein the information identifying the piece of content and the information identifying the current playback position facilitate a retrieval of the piece of content and an initiation of playback of the piece of content from the current playback position at the second media device.

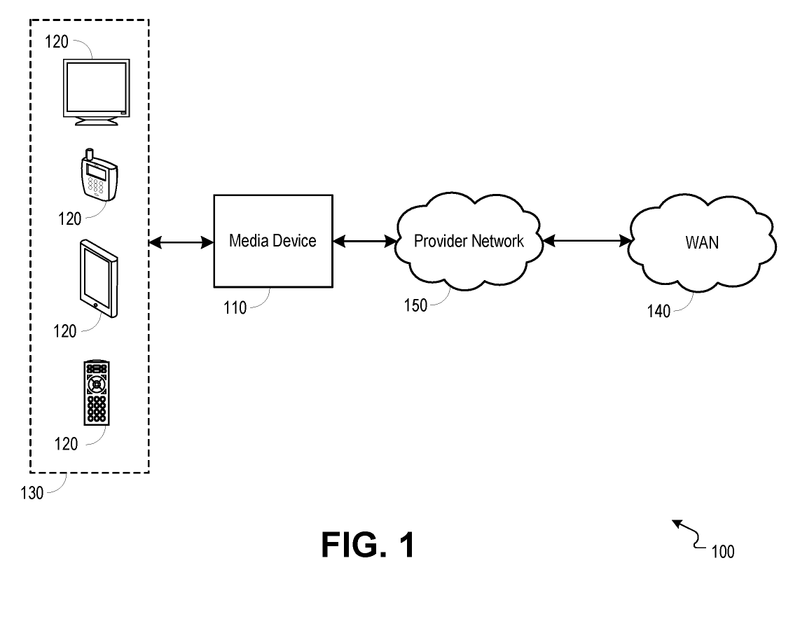

FIG. 1 is a block diagram illustrating an example network environment 100 operable to facilitate the transport of content and playback position information from one media device to another. In embodiments, a media device 110 may be configured to provide one or more services to one or more client devices 120, the one or more services including video or multimedia services, data services, voice services, and/or others. The media device 110 may include a multimedia or residential gateway, a set-top box (STB), an access point, a network extender, or any other device configured to deliver one or more services to one or more client devices 120. Client devices 120 may include televisions, computers, tablets, mobile devices, STBs, game consoles, remote control units (RCUs), and any other device configured to receive a service from an access device.

In embodiments, services may be delivered from the media device 110 to one or more client devices 120 over a local network 130 (e.g., a local area network (LAN), a wireless local area network (WLAN), a personal area network (PAN), etc.). The media device 110 may receive services from and may communicate with an upstream wide area network (WAN) 140 through a connection to a provider network 150. It should be understood that the media device 110 may operate as an access point to wirelessly deliver one or more services to one or more client devices 120 that are associated with (e.g., paired with or authenticated with) the media device 110 as stations. For example, the one or more client devices 120 may be configured with network parameters (e.g., network name, service set identifier (SSID), wireless channel, network PIN/password/passphrase/passcode, etc.) associated with a wireless network provided by the media device 110, thereby allowing the client devices 120 and the media device 110 to communicate with each other. It should be understood that various protocols and/or standards (e.g., Wi-Fi, multimedia over coax alliance (MoCA), ZigBee, etc.) may be used to deliver communications between a media device 110 and client device 120.

In embodiments, a media device 110 may be configured to wirelessly transmit content and playback position information to a client device 120 (e.g., a client device 120 having a wireless capability). For example, the content information may include an identification and other information associated with a piece of content currently being output from the media device 110 (e.g., program title, channel identifier, uniform resource identifier (URI) such as a uniform resource locator (URL) or other content source identifier), and the playback position information may include an identification of a current playback position within the piece of content (e.g., a temporal identification, packet identification, or other reference that indicates the playback position within the piece of content at the instance at which the content and playback position information was requested by the client device 120). The content and playback position information may be downloaded from the media device 110 to the client device 120, and the content and playback position information may be stored temporarily on the client device 120. In embodiments, the client device 120 may be a bi-directional remote control unit (RCU) (e.g., Bluetooth/RF4CE (radio frequency for consumer electronics) device, Bluetooth low energy (BLE) device, etc.) or any other device capable of receiving and transmitting wireless communications (e.g., short range wireless signals such as Bluetooth or RF4CE transmission). For example, the client device 120 may be an RCU, a computer, a mobile device, a tablet, or other device that may be carried from the media device 110 to another media device 110 or a client device 120.

The user may then take the client device 120 (e.g., the wireless device onto which the content and playback position information has been downloaded) to another media device 110 or other client device 120 and select an option to initiate content playback at the other media device 110 or other client device 120 according to the content and playback position information stored on the client device 120. The other media device 110 or other client device 120 may be identified by the client device 120 based upon a measured proximity of the client device 120 to the other media device 110 or other client device 120, by a user selection of a certain device from a list of one or more available devices (e.g., a list generated as a user interface at the client device 120), or other method.

In embodiments, the user may select an option on the client device 120 (e.g., by depressing a certain designated button or designated sequence of buttons on the client device 120) to start playback, at the identified media device 110 or client device 120, of the content identified within the information stored on the client device 120 from the point in the piece of content identified within the information stored on the client device 120. In response to the selection of the option by the user, the client device 120 may output one or more wireless transmissions (e.g., Bluetooth or other RF signal(s)) that include the content and playback position information temporarily stored at the client device 120.

Using the content and playback position information received from the client device 120, the identified media device 110 or client device 120 may retrieve the piece of content identified by the content information and may start playback of the piece of content from the point identified by the playback position information. For example, the identified media device 110 may retrieve the piece of content from an upstream network (e.g., WAN 140, upstream server such as a VoD (video-on-demand) server, etc.), from another device (e.g., STB, DVR (digital video recorder), gateway device) associated with or connected to the local network 130, or other location identified by the content and playback position information.

While content and playback position information is used to describe the data communicated from a client device 120 to a media device 110 or other client device 120, it should be understood that other types of information may be communicated from a first media device to a second media device using the methods and systems described herein. For example, a client device 120 may download a favorite channel list or viewer profile information from a first media device, and the client device 120 may communicate the favorite channel list or viewer profile information to a second media device over a wireless link (e.g., Bluetooth connection).

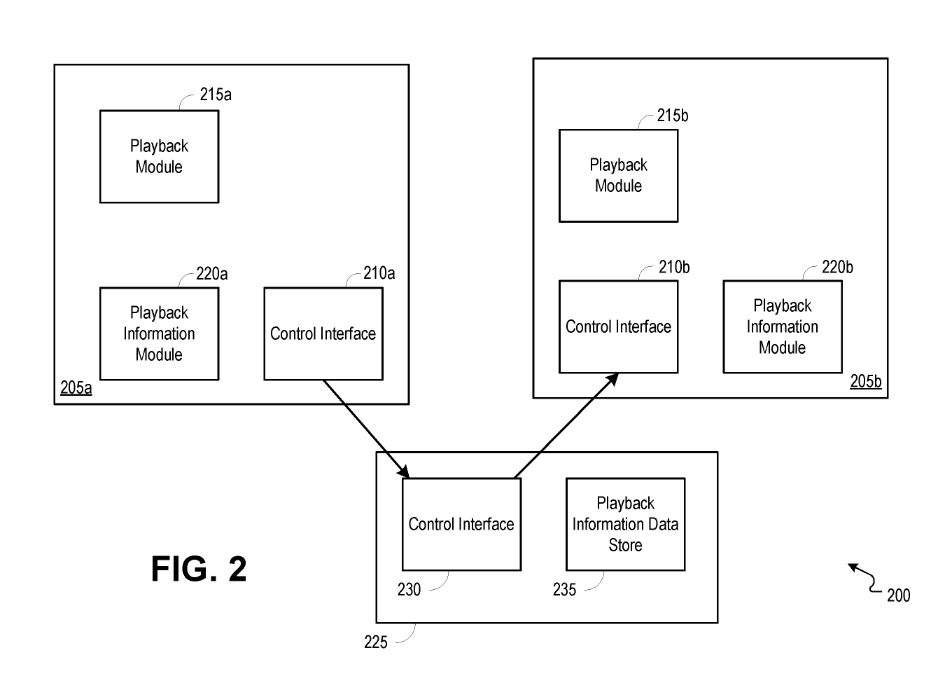

FIG. 2 is a block diagram illustrating an example system 200 operable to facilitate the transport of content and playback position information from one device 205a to another device 205b. In embodiments, a device 205a-b may include a control interface 210a-b, a playback module 215a-b, and a playback information module 220a-b. In embodiments, a device 205a-b may be a media device 110 of FIG. 1, a client device 120 of FIG. 1, or any other device configured to provide multimedia content to a viewer.

In embodiments, a device 205a may be configured to wirelessly transmit content and playback position information to a wireless device 225 (e.g., a client device 120 having a wireless capability). For example, the content information may include an identification of a piece of content and other information associated with the piece of content currently being output by a playback module 215a (e.g., program title, channel identifier, uniform resource identifier (URI) such as a uniform resource locator (URL) or other content source identifier), and the playback position information may include an identification of a current playback position within the piece of content (e.g., a temporal identification, packet identification, or other reference that indicates the playback position within the piece of content at the instance at which the content and playback position information was requested by the client device 120). The content and playback position information may be received at the wireless device 225 through a control interface 230 (e.g., a wireless interface supporting the reception and transmission of wireless communications including RF signals, Bluetooth signals, BLE signals, etc.), and the content and playback position information may be stored temporarily on the wireless device 225 at a playback information data store 235. In embodiments, the wireless device 225 may be a bi-directional remote control unit (RCU) (e.g., Bluetooth/RF4CE (radio frequency for consumer electronics) device, Bluetooth low energy (BLE) device, etc.) or any other device capable of receiving and transmitting wireless communications (e.g., short range wireless signals such as Bluetooth or RF4CE transmission). For example, the wireless device 225 may be an RCU, a computer, a mobile device, a tablet, or other device that may be carried from the device 205a to a device 205b.

It should be understood that other information may be stored at the playback information data store 235 of the wireless device 225. For example, profile information including user preferences, favorite channels, programs, or genres, recording history, and other information may be stored within the playback information data store 235 for one of more users. The profile information may be wirelessly transmitted to a media device when the wireless device 225 is associated with the media device, and the media device may use the profile information to generate customized user guides, recommend programming based on user preferences, generate a personalized list of recordings associated with a user, and to carry out various other functions.

After the content and playback position information has been stored on the wireless device 225, another device (e.g., device 205b) may be identified. The other device may be identified, for example, by a user identification of the device from a list of one or more available devices, a pairing of the wireless device 225 to the other device (e.g., Bluetooth pairing), a determination that the wireless device 225 is within a certain range associated with the device, or other indicator or technique. When the device 205b has been identified, content playback at the device 205b may be initiated according to the content and playback position information stored on the wireless device 225.

In embodiments, the wireless device 225 may respond to a user input/command (e.g., depressing of a certain designated button or designated sequence of buttons on the wireless device 225) by outputting the content and playback position information (e.g., information stored at the playback information data store 235) to the identified device 205b. For example, the wireless device 225 may output the content and playback position information to the device 205b as one or more wireless signals (e.g., Bluetooth, BLE, or other RF signal(s)) transmitted through the control interface 225.

Using the content and playback position information received from the wireless device 225 through the control interface 210b, the identified device 205b may retrieve the piece of content identified by the content information and may start playback of the piece of content from the point identified by the playback position information. For example, the identified device 205b may retrieve the piece of content from an upstream network (e.g., WAN 140 of FIG. 1, upstream server such as a VoD (video-on-demand) server, etc.), from another device (e.g., STB, DVR (digital video recorder), gateway device, device 205a, etc.) associated with or connected to a common local network, or other location identified by the content and playback position information. The playback information module 220b may extract the content and playback position information from the one or more wireless signals received from the wireless device 225, and the playback information module 220b may cause the playback module 215b to initiate playback of the identified piece of content from a resume point identified by the playback position information.

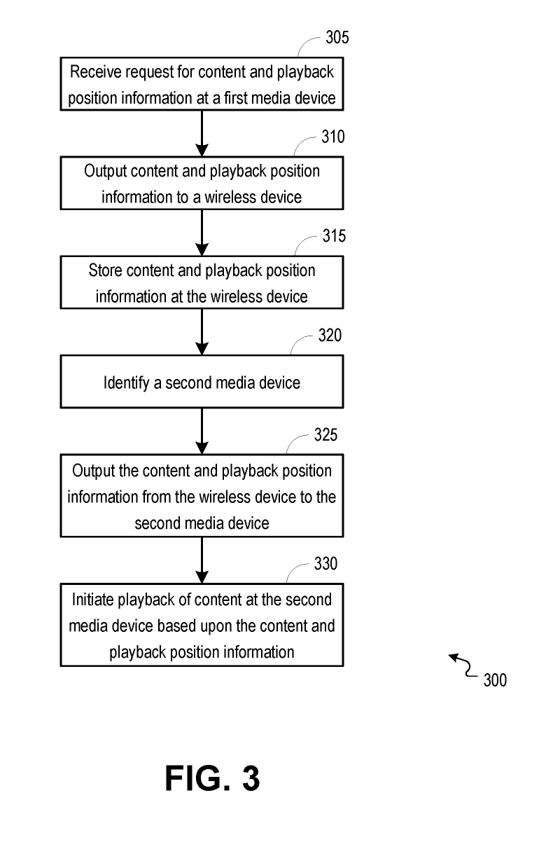

FIG. 3 is a flowchart illustrating an example process 300 operable to facilitate the transport of content and playback position information from one media device to another. The process 300 can begin at 305 when a request for content and playback position information is received at a first media device. For example, the request for content and playback position information may be received at a device 205a of FIG. 2 (e.g., through a control interface 210a of FIG. 2) and may be recognized by a playback information module 220a of FIG. 2. In embodiments, the request for the content and playback position information may be received from a wireless device (e.g., wireless device 225 of FIG. 2). For example, the request may be transmitted from the wireless device as a wireless signal (e.g., radio frequency (RF), infrared (IR), etc.). The wireless device 225 may be a bi-directional RCU such as a Bluetooth, Zigbee, or RF4CE (radio frequency for consumer electronics) device, or may be any other device configured to receive and transmit wireless communications (e.g., tablet, mobile device, etc.).

At 310, content and playback position information may be output to a wireless device. In response to the request for content and playback position information, the first media device may gather and output content and playback position information to the wireless device (e.g., wireless device 225). For example, a playback information module 220a of the first media device may gather information associated with the current playback of content at the first media device (e.g., from a playback module 215a of FIG. 2 of the first media device), and the information may be transmitted to the wireless device 225 through a control interface 210a of FIG. 2. In embodiments, the content information may include an identifier (e.g., URL, URI, etc.) of the content being output from the first media device, and the playback position information may include an identification of a current position (e.g., time, frame, packet reference, etc.) of the content being output from the first media device. The content and playback position information may be output from the first media device to the wireless device 225 as one or more wireless transmissions or signals (e.g., RF, Bluetooth, BLE signal, etc.). The wireless device 225 may be a bi-directional RCU or other wireless device and may recognize and accept one or more wireless signals carrying the information from the first media device.

At 315, the content and playback position information may be stored at the wireless device. For example, the wireless device (e.g., wireless device 225) may include storage and the information may be stored within the storage of the wireless device.

At 320, a second media device may be identified. The second media device (e.g., device 205b of FIG. 2) may be identified by pairing (e.g., though a Bluetooth or BLE pairing process) the wireless device with the second media device, by selecting an identifier of the second media device from a user interface listing one or more media devices, by determining that the wireless device is within a predetermined range or proximity of the second media device, or through various other means.

At 325, the content and playback position information may be output from the wireless device to the second media device. In embodiments, a certain command may be input (e.g., a certain button is depressed or a certain sequence of buttons depressed) at the wireless device that is designated for resuming playback of content based on information stored at the wireless device, and in response, the wireless device may output the content and playback position information that is stored at the wireless device. For example, the content and playback position information may be output from the wireless device to the second media device as one or more wireless signals.

At 330, a playback of content may be initiated at the second media device based upon the content and playback position information. In embodiments, a playback information module 220b of FIG. 2 of the second media device (e.g., device 2205b of FIG. 2) may retrieve the content and playback position information from the one or more wireless signals received from the wireless device, and the playback module 215b of FIG. 2 may use the information to identify and retrieve the content (e.g., the content identified by the content information) and to initiate playback of the content from a position indicated by the retrieved playback position information. For example, the playback module 215b may use a playback position reference (e.g., temporal, frame, packet reference, etc.) included within the retrieved information to identify a playback position within the content, and the playback module 215b may initiate an output of the content to a display from the identified playback position.

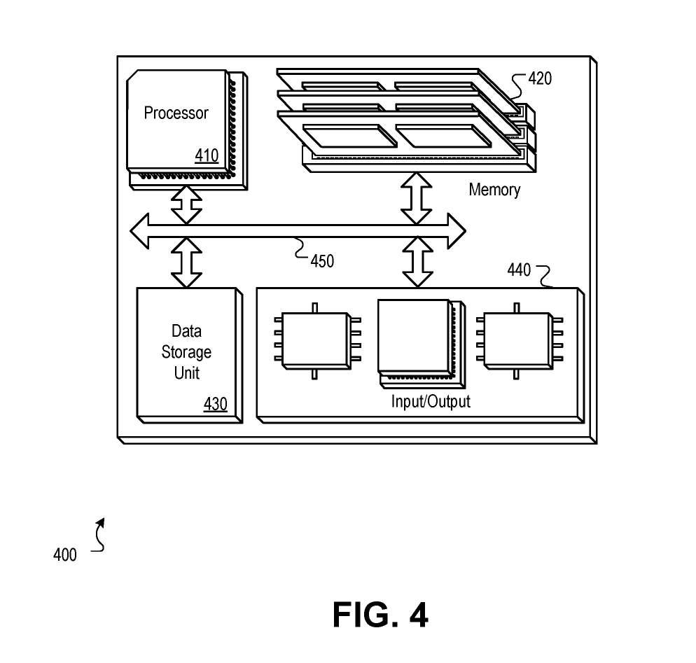

FIG. 4 is a block diagram of a hardware configuration 400 operable to facilitate the transport of content and playback position information from one media device to another. The hardware configuration 400 can include a processor 410, a memory 420, a storage device 430, and an input/output device 440. Each of the components 410, 420, 430, and 440 can, for example, be interconnected using a system bus 450. The processor 410 can be capable of processing instructions for execution within the hardware configuration 400. In one implementation, the processor 410 can be a single-threaded processor. In another implementation, the processor 410 can be a multi-threaded processor. The processor 410 can be capable of processing instructions stored in the memory 420 or on the storage device 430.

The memory 420 can store information within the hardware configuration 400. In one implementation, the memory 420 can be a computer-readable medium. In one implementation, the memory 420 can be a volatile memory unit. In another implementation, the memory 420 can be a non-volatile memory unit.

In some implementations, the storage device 430 can be capable of providing mass storage for the hardware configuration 400. In one implementation, the storage device 430 can be a computer-readable medium. In various different implementations, the storage device 430 can, for example, include a hard disk device, an optical disk device, flash memory or some other large capacity storage device. In other implementations, the storage device 430 can be a device external to the hardware configuration 400.

The input/output device 440 provides input/output operations for the hardware configuration 400. In one implementation, the input/output device 440 can include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 802.11 card), and/or one or more interfaces for outputting video and/or data services to a media device (e.g., media device 110 of FIG. 1), a client device (e.g., client device 120 of FIG. 1), and/or a wireless device (e.g., wireless device 225 of FIG. 2). In embodiments, the input/output device can include driver devices configured to send communications to, and receive communications from one or more networks (e.g., WAN 140 of FIG. 1, provider network 150 of FIG. 1, local network 130 of FIG. 1, etc.).

Those skilled in the art will appreciate that the invention improves upon methods and systems for resuming playback of content at a different media device. Methods, systems, and computer readable media may facilitate the transport of content and playback position information from one media device to another. In embodiments, a wireless device such as a bi-directional remote control unit (e.g., Bluetooth, or RF4CE (radio frequency for consumer electronics)) or other device configured to receive and transmit wireless communications may be used to download, from a media device, and temporarily store information associated with content being output by the media device, wherein the information includes an identification of the content being output and an identification of a current playback or resume point within the piece of content. The wireless device may transmit the information associated with the content to a second media device, and the second media device may use the information to retrieve the piece of content identified by the information and to initiate playback of the content from the position identified by the information.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

We claim:

1. A method comprising:
receiving, at a wireless device, information identifying a piece of content that is being output from a first media device and information identifying a current playback position of the output of the piece of content from the first media device, wherein the information identifying the piece of content and the information identifying the current playback position are received from the first media device within one or more wireless transmissions;
storing the information identifying the piece of content and the information identifying the current playback position at the wireless device;
identifying a second media device; and
outputting the information identifying the piece of content and the information identifying the current playback position from the wireless device to the second media device, wherein the information identifying the piece of content and the information identifying the current playback position are output within one or more wireless transmissions, and wherein the information identifying the piece of content and the information identifying the current playback position facilitate a retrieval of the piece of content and an initiation of playback of the piece of content from the current playback position at the second media device.

2. The method of claim 1, wherein the wireless device comprises a bi-directional remote control unit.

3. The method of claim 1, wherein the information identifying the piece of content and the information identifying the current playback position are received at the wireless device in response to a designated user input being received at the wireless device.

4. The method of claim 1, wherein the second media device is identified and the information identifying the piece of content and the information identifying the current playback position are output to the second media device in response to a designated user input being received at the wireless device.

5. The method of claim 1, wherein identifying the second media device comprises:
determining that the wireless device is paired with the second media device.

6. The method of claim 1, wherein identifying the second media device comprises:
determining that the wireless device is within a predetermined range of the second media device.

7. The method of claim 1, wherein the one or more wireless transmissions carrying the information identifying the piece of content and the information identifying the current playback position from the first media device to the wireless device comprise one or more Bluetooth or Radio Frequency for Consumer Electronics transmissions.

8. A wireless device comprising:
an interface configured to be used to receive information identifying a piece of content that is being output from a first media device and information identifying a current playback position of the output of the piece of content from the first media device, wherein the information identifying the piece of content and the information identifying the current playback position are received from the first media device within one or more wireless transmissions;
storage configured to store the information identifying the piece of content and the information identifying the current playback position at the wireless device;
one or more modules configured to identify a second media device; and
wherein the interface is further configured to be used to output the information identifying the piece of content and the information identifying the current playback position from the wireless device to the second media device, wherein the information identifying the piece of content and the information identifying the current playback position are output within one or more wireless transmissions, and wherein the information identifying the piece of content and the information identifying the current playback position facilitate a retrieval of the piece of content and an initiation of playback of the piece of content from the current playback position at the second media device.

9. The wireless device of claim 8, wherein the information identifying the piece of content and the information identifying the current playback position are received in response to a designated user input being received at the wireless device.

10. The wireless device of claim 8, wherein the second media device is identified and the information identifying the piece of content and the information identifying the current playback position are output to the second media device in response to a designated user input being received at the wireless device.

11. The wireless device of claim 8, wherein identifying the second media device comprises:
determining that the wireless device is paired with the second media device.

12. The wireless device of claim 8, wherein identifying the second media device comprises:
determining that the wireless device is within a predetermined range of the second media device.

13. The wireless device of claim 8, wherein the one or more wireless transmissions carrying the information identifying the piece of content and the information identifying the current playback position from the first media device to the wireless device comprise one or more Bluetooth or Radio Frequency for Consumer Electronics transmissions.

14. One or more non-transitory computer readable media having instructions operable to cause one or more processors to perform the operations comprising:
receiving, at a wireless device, information identifying a piece of content that is being output from a first media device and information identifying a current playback position of the output of the piece of content from the first media device, wherein the information identifying the piece of content and the information identifying the current playback position are received from the first media device within one or more wireless transmissions;
storing the information identifying the piece of content and the information identifying the current playback position at the wireless device;
identifying a second media device; and
outputting the information identifying the piece of content and the information identifying the current playback position from the wireless device to the second media device, wherein the information identifying the piece of content and the information identifying the current playback position are output within one or more wireless transmissions, and wherein the information identifying the piece of content and the information identifying the current playback position facilitate a retrieval of the piece of content and an initiation of playback of the piece of content from the current playback position at the second media device.

15. The one or more non-transitory computer-readable media of claim 14, wherein the wireless device comprises a bi-directional remote control unit.

16. The one or more non-transitory computer-readable media of claim 14, wherein the information identifying the piece of content and the information identifying the current playback position are received at the wireless device in response to a designated user input being received at the wireless device.

17. The one or more non-transitory computer-readable media of claim 14, wherein the second media device is identified and the information identifying the piece of content and the information identifying the current playback position are output to the second media device in response to a designated user input being received at the wireless device.

18. The one or more non-transitory computer-readable media of claim 14, wherein identifying the second media device comprises:
determining that the wireless device is paired with the second media device.

19. The one or more non-transitory computer-readable media of claim 14, wherein identifying the second media device comprises:
determining that the wireless device is within a predetermined range of the second media device.

20. The one or more non-transitory computer-readable media of claim 14, wherein the one or more wireless transmissions carrying the information identifying the piece of content and the information identifying the current playback position from the first media device to the wireless device comprise one or more Bluetooth or Radio Frequency for Consumer Electronics transmissions.
